(19) United States
(12) Patent Application Publication
(10) Pub. No.: US 2014/0362005 A1
(43) Pub. Date: Dec. 11, 2014

(54) INFORMATION TERMINAL DEVICE, KEY CORRECTION METHOD, AND RECORDING MEDIUM

(71) Applicant: FUJITSU LIMITED, Kawasaki-shi (JP)

(72) Inventors: Yuko Yazawa, Saitama (JP); Kazunori Kasuga, Yokohama (JP); Hirofumi Shimizu, Kawasaki (JP); Katsutoshi Kondo, Funabashi (JP)

(73) Assignee: FUJITSU LIMITED, Kawasaki-shi (JP)

(21) Appl. No.: 14/265,461

(22) Filed: Apr. 30, 2014

(30) Foreign Application Priority Data
Jun. 5, 2013 (JP) 2013-119301

(51) Int. Cl. G06F 3/041; G06F 3/0488

(52) U.S. Cl. CPC G06F 3/041; G06F 3/04886
USPC 345/173

(57) ABSTRACT

An information terminal device includes an input unit that inputs, when a touch operation performed in a detection area that is associated with one of keys of a software keyboard displayed on a screen has been detected, a character associated with the key in the detection area. The information terminal device includes a determining unit that determines, when a modification of a character input by the input unit has been detected, whether the key of the pre-modification character is adjacent to a key of a post-modification character in the layout of the software keyboard. The information terminal device includes a correcting unit that extends, when the determining unit determines that the key of the pre-modification character is adjacent to the key of the post-modification character, the detection area of the key associated with the post-modification character in the arrangement direction of the key that is associated with the pre-modification character.

### CROSS-REFERENCE TO RELATED APPLICATION

This application is based upon and claims the benefit of priority of the prior Japanese Patent Application No. 2013-119301, filed on Jun. 5, 2013, the entire contents of which are incorporated herein by reference.

### FIELD

The embodiments discussed herein are related to an information terminal device, a key correction method, and a recording medium.

### BACKGROUND

Information terminal devices, such as tablet devices or smart phones, have a function of, for example, displaying a software keyboard or the like on a displayed screen and inputting characters associated with keys on the software keyboard by using a touch panel function. An example of related art is described in Japanese Laid-open Patent Publication No. 11-25080, Japanese Laid-open Patent Publication No. 10-198481 and Japanese Laid-open Patent Publication No. 6-314167.

However, with the information terminal devices, if the size of a displayed screen that displays a software keyboard is small, because a detection area in which the touch operation performed on one of keys on the software keyboard is detected is small, an erroneous operation due to an adjacent key being erroneously touched occurs. Consequently, a character is erroneously input at the time of the erroneous operation due to the adjacent key being erroneously touched.

Consequently, if users of the information terminal device erroneously operate the adjacent key on the software keyboard, the users need to correct the erroneously input character each time, which is a large burden for the users.

### SUMMARY

According to an aspect of an embodiment, an information terminal device includes an input unit that inputs, when an operation for specifying a detection area that is associated with one of keys on a software keyboard that is displayed on a screen has been detected, a character associated with the key in the detection area; a determining unit that determines, when a modification of the character input by the input unit has been detected, whether the key of the pre-modification character is adjacent to a key of a post-modification character in the layout of the software keyboard; and a correcting unit that extends, when the determining unit determines that the key of the pre-modification character is adjacent to the key of the post-modification character, the detection area of the key that is associated with the post-modification character in the arrangement direction of the key that is associated with the pre-modification character.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of an information terminal device according to a first embodiment;

FIG. 2 is a schematic diagram illustrating an example of a layout screen of a software keyboard;

FIG. 3 is a schematic diagram illustrating an example of a coordinate table;

FIG. 4 is a schematic diagram illustrating an example of an adjacent character table;

FIG. 5 is a schematic diagram illustrating an example of the detection coordinates in a detection area;

FIG. 6 is a flowchart illustrating an example of the flow of a first key correction process performed by a processor in the information terminal device;

FIG. 7 is a flowchart illustrating an example of the flow of an adjacent character identifying process performed by the processor;

FIG. 8 is a flowchart illustrating an example of the flow of a detection coordinates correction process performed by the processor;

FIG. 9 is a flowchart illustrating an example of the flow of a second key correction process performed by the processor;

FIG. 10 is a flowchart illustrating an example of the flow of a third key correction process performed by the processor;

FIG. 11 is a block diagram illustrating an example of the configuration of an information terminal device according to a second embodiment;

FIG. 12 is a schematic diagram illustrating an example of a modification count table;

FIG. 13 is a flowchart illustrating an example of the flow of a fourth key correction process performed by the processor in the information terminal device;

FIG. 14 is a schematic diagram illustrating an example of a layout screen of a software keyboard with QWERTY layout;

FIG. 15 is a schematic diagram illustrating an example of a layout screen of a software keyboard with Japanese Kana characters;

FIG. 16 is a schematic diagram illustrating an example of a layout screen of a software keyboard with a numeric keypad; and

FIG. 17 is a block diagram illustrating an example of an information processing apparatus that executes a key correction program.

### DESCRIPTION OF EMBODIMENTS

Preferred embodiments of the present invention will be explained with reference to accompanying drawings. The present invention is not limited to these embodiments. Furthermore, the embodiments can be appropriately used in combination as long as processes do not conflict with each other.

### [a] First Embodiment

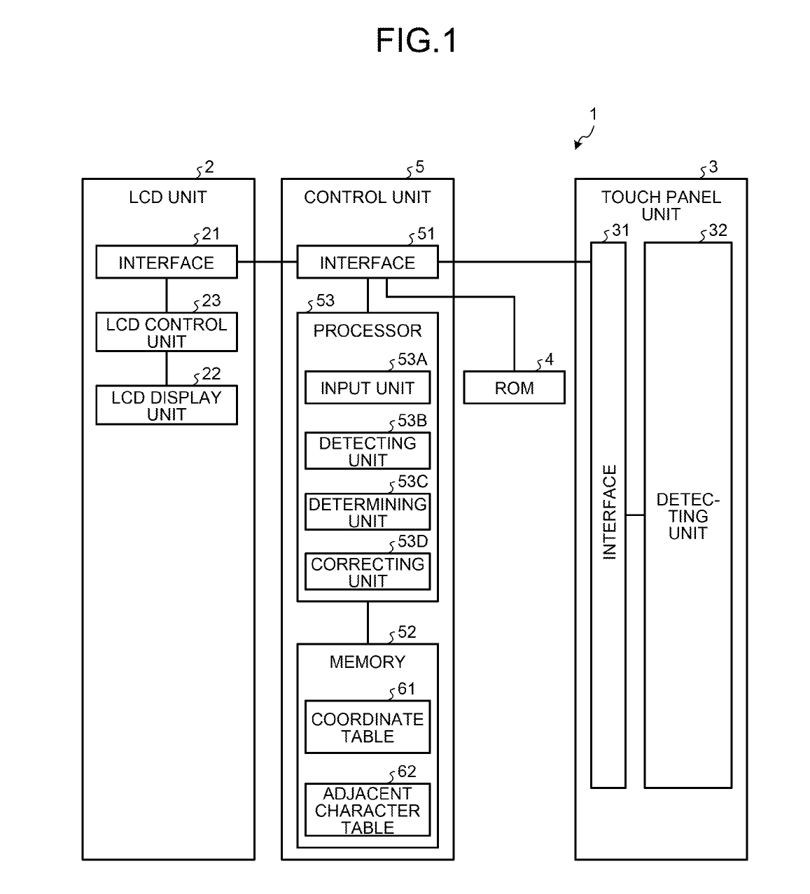

FIG. 1 is a block diagram illustrating an example of the configuration of an information terminal device 1 according to a first embodiment. The information terminal device 1 illustrated in FIG. 1 includes a liquid crystal display (LCD) unit 2, a touch panel unit 3, a read only memory (ROM) 4, and a control unit 5. The LCD unit 2 includes an interface 21, an LCD display unit 22, and an LCD control unit 23. The interface 21 is an interface that is connected to the control unit 5. The LCD display unit 22 is a display unit that displays, on a screen, an operation screen, such as a software keyboard with a predetermined layout or the like, or various kinds of information. The LCD control unit 23 controls the LCD display unit 22.

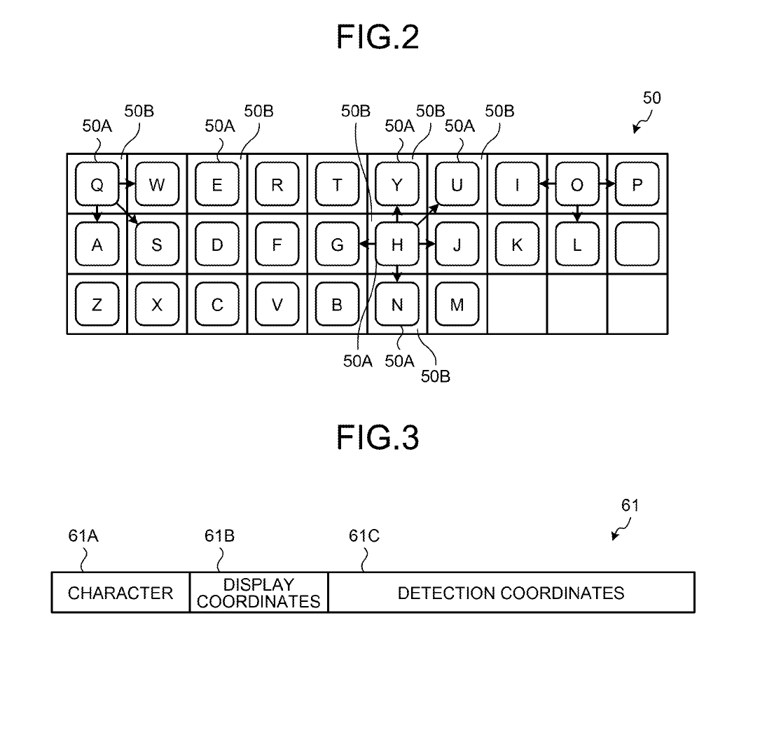

The touch panel unit 3 includes an interface 31 and a detecting unit 32. The interface 31 is an interface that is connected to the control unit 5. The detecting unit 32 is a touch sensor, such as a resistive touch sensor, a surface-acoustic-wave sensor, an infrared sensor, an electromagnetic guidance sensor, a capacitive touch sensor, or the like, that detects a touch operation performed by a user for each detection area of a key of a software keyboard that is being displayed on the screen of the LCD display unit 22. FIG. 2 is a schematic diagram illustrating an example of a layout screen of a software keyboard 50. As illustrated in FIG. 2, the LCD unit 2 displays, on the screen, the software keyboard 50 on which keys 50A that are used to input a character are arranged. Furthermore, the touch panel unit 3 on the LCD unit 2 is divided into detection areas 50B, for each key 50A of the software keyboard 50, in which a touch operation performed on the keys 50A is detected. The ROM 4 is a storing area that stores therein various kinds of information on programs or various kinds of information on the software keyboard 50.

The control unit 5 includes an interface 51, a memory 52, and a processor 53. The interface 51 is an interface that is connected to the LCD unit 2, the touch panel unit 3, and the ROM 4. The memory 52 is a storing area that stores therein various kinds of information. The processor 53 performs overall control of the control unit 5.

The memory 52 stores therein a coordinate table 61 and an adjacent character table 62. FIG. 3 is a schematic diagram illustrating an example of the coordinate table 61. The coordinate table 61 illustrated in FIG. 3 stores therein, in an associated manner for each of key 50A of the software keyboard 50, a character 61A, a display coordinates 61B, and detection coordinates 61C. The character 61A is an input character that is associated with the touch operation of the key 50A. The display coordinates 61B are the coordinates displayed on the LCD display unit 22 associated with one of the keys 50A of the software keyboard 50. The detection coordinates 61C are the coordinates in the detection area 50B of the touch panel unit 3 associated with each of the keys 50A of the software keyboard 50. The display coordinates and the detection coordinates are managed by the x-y coordinates, which will be described later, and are obtained by dividing a screen area on the displayed screen. The processor 53 refers to the coordinate table 61 and recognizes, for example, the character 61A, the display coordinates 61B, and the detection coordinates 61C of each of the keys 50A on the software keyboard 50.

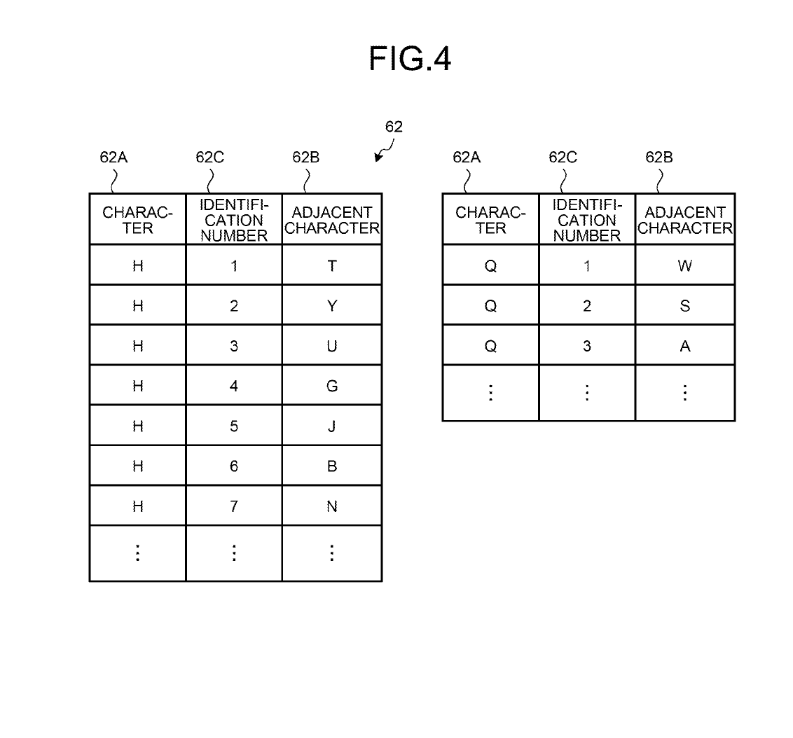

FIG. 4 is a schematic diagram illustrating an example of the adjacent character table 62. The adjacent character table 62 illustrated in FIG. 4 stores therein, in an associated manner, a character 62A, an adjacent character 62B, and an identification number 62C. The character 62A is a character that is associated with one of the keys 50A on the software keyboard 50 with a predetermined layout. The adjacent character 62B is a character that is associated, for each character 62A, with one of the keys 50A adjacent to the key 50A of the subject character of the software keyboard 50 with the predetermined layout. The identification number 62C is the number for identifying, for each character 62A, each of the adjacent characters 62B. The adjacent character table 62 stores therein, in an associated manner, “T” as the adjacent character 62B of “H” and “1” as the identification number 62C; “Y” as the adjacent character 62B of “H” and “2” as the identification number 62C; “U” as the adjacent character 62B of “H” and “3” as the identification number 62C; “G” as the adjacent character 62B of “H” and “4” as the identification number 62C; “J” as the adjacent character 62B of “H” and “5” of the identification number 62C; “B” as the adjacent character 62B of “H” and “6” as the identification number 62C; “N” as the adjacent character 62B of “H” and “7” as the identification number 62C; and “M” as the adjacent character 62B of “H” and “8” as the identification number 62C.

Furthermore, the adjacent character table 62 stores therein, in an associated manner, “W” as the adjacent character 62B of “Q” and “1” as the identification number 62C; “S” as the adjacent character 62B of “Q” and “2” as the identification number 62C; and “A” as the adjacent character 62B of “Q” and “3” as the identification number 62C. The processor 53 refers to the adjacent character table 62 and recognizes, for example, the character 62A, the adjacent character 62B, and the identification number 62C of each of the keys 50A of the software keyboard 50.

The processor 53 reads a program stored in the ROM 4 and functions, on the basis of the read program, as processes performed by an input unit 53A, a detecting unit 53B, a determining unit 53C, and a correcting unit 53D. The input unit 53A detects, via the detecting unit 32 in the touch panel unit 3, the touch operation performed in the detection area 50B that is associated with each of the keys 50A on the software keyboard 50 on the displayed screen. When the input unit 53A detects a touch operation in the detection area 50B, the input unit 53A refers to the coordinate table 61 illustrated in FIG. 3, reads the character 61A that is associated with the detection coordinates 61C in the detection area 50B performed by the touch operation, and then performs a character input.

When the detecting unit 53B detects a modification of a character input by the input unit 53A, the detecting unit 53B stores the pre-modification character and a post-modification character in a work area in the memory 52. When the determining unit 53C detects the modification of the input character, the determining unit 53C refers to the adjacent character table 62 illustrated in FIG. 4 and determines whether the key 50A of the pre-modification character is adjacent to the key 50A of the post-modification character. If, for example, the post-modification character is “H” and the pre-modification character is “G”, the determining unit 53C refers to the adjacent character table 62 and determines whether the pre-modification character of “G” is present in the item of the adjacent character that is associated with the post-modification character of “H”. If the pre-modification character of “G” is present in the adjacent character that is associated with the post-modification character of “H”, the determining unit 53C determines that the key 50A of the pre-modification character “G” is adjacent to the key 50A of the post-modification character “H”.

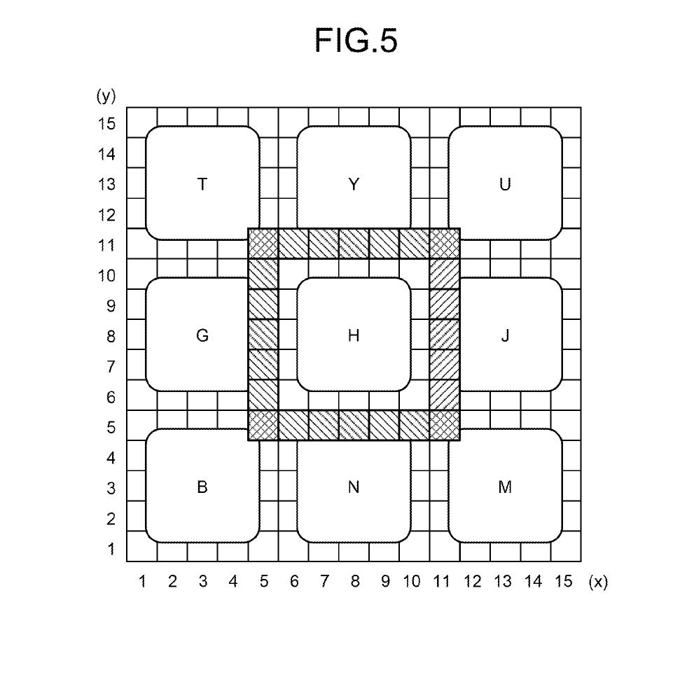

FIG. 5 is a schematic diagram illustrating an example of the detection coordinates in the detection area 50B. The detection coordinates in the detection area 50B illustrated in FIG. 5 is divided into areas of x-y coordinates on the displayed screen for each of the keys 50A of, for example, “T”, “Y”, “U”, “G”, “H”, “J”, “B”, “N”, and “M”. For example, the detection coordinates of “H” in the detection area 50B is in the area of, as an initial value, (6,6) to (6,10), (6,10) to (10,10), (10, 10) to (10,6), (10,6) to (6,6). Furthermore, the detection coordinates of “T” in the detection area 50B is in the area of, an initial value, (1,11) to (5,11), (5,11) to (5,15), (5, 15) to (1,15), (1,15) to (1,11).

If one of the keys 50A of the pre-modification character is adjacent to one of the keys 50A of the post-modification character, the correcting unit 53D extends the detection coordinates in the detection area 50B that is associated with the key 50A of the post-modification character in the arrangement direction of the key 50A that is associated with the pre-modification character. As illustrated in FIG. 5, if the pre-modification character is “J” and the post-modification character is “H”, the correcting unit 53D extends the detection coordinates in the detection area 50B that is associated with the key 50A of “H”, which is the post-modification character, in the arrangement direction of the key 50A of “J”, which is the pre-modification character, by an area of the detection coordinates (11,6) to (11,10)((11,6),(11,7),(11,8),(11,9) and (11,10)). Because the correcting unit 53D extends the detection coordinates of “H”, which is the post-modification character, by an area that is a part of area of the detection coordinates of “J”, which is the pre-modification character, the correcting unit 53D reduces, by an area corresponding to the extended size, the area of the detection coordinates of “J”, which is the pre-modification character.

Furthermore, for example, if the pre-modification character is “Y”, the correcting unit 53D extends the detection coordinates in the detection area 50B that is associated with the key 50A of “H” of the post-modification character by an area of detection coordinates (6,11) to (10,11) ((6,11),(7,11),(8,11),(9,11) and (10,11)), in the arrangement direction of the key 50A of “Y”, which is the pre-modification character. Furthermore, for example, if the pre-modification character is “G”, the correcting unit 53D extends the detection coordinates in the detection area 50B that is associated with the key 50A of “H” of the post-modification character by an area of detection coordinates (5,10) to (5,6)((5,10),(5,9),(5,8),(5,7) and (5,6)) in the arrangement direction of the key 50A of “G” of the pre-modification character. Furthermore, for example, if the pre-modification character is “N”, the correcting unit 53D extends the detection coordinates in the detection area 50B that is associated with the key 50A of “H” of the post-modification character by an area, in the arrangement direction of the key 50A of “N” of the pre-modification character, the detection coordinates (6,5) to (10,5) ((6,5),(7,5),(8,5),(9,5) and (10,5)).

Furthermore, for example, if the pre-modification character is “T”, the correcting unit 53D extends the detection coordinates in the detection area 50B that is associated with the key 50A of “H” of the post-modification character by an area of the detection coordinates (5,11) in the arrangement direction of the key 50A of “T” of the pre-modification character. Furthermore, for example, if the pre-modification character is “U”, the correcting unit 53D extends the detection coordinates in the detection area 50B that is associated with the key 50A of “H” of the post-modification character by an area in the arrangement direction (11,11) of the key 50A of “U” of the pre-modification character. Furthermore, for example, if the pre-modification character is “B”, the correcting unit 53D extends the detection coordinates in the detection area 50B that is associated with the key 50A of “H” of the post-modification character by an area of the detection coordinates (5,5) in the arrangement direction of the key 50A of “B” of the pre-modification character. Furthermore, for example, if the pre-modification character is “M”, the correcting unit 53D extends the detection coordinates in the detection area 50B that is associated with the key 50A of “H” of the post-modification character by an area of the detection coordinates (11,5) in the arrangement direction of the key 50A of “M” of the pre-modification character. Furthermore, for convenience of description, a description has been given of the key 50A adjacent to the post-modification character of “H”; however, the post-modification character is not limited to “H”. For example, if the post-modification character is “N” and the pre-modification character “M”, the key 50A of the pre-modification character is adjacent to the key 50A of the post-modification character. Consequently, the correcting unit 53D extends the detection coordinates in the detection area 50B that is associated with the key 50A of “N” of the post-modification character by an area of the detection coordinates (11,5) to (11,1) ((11,5),(11,4),(11,3),(11,2) and (11,1)) in the arrangement direction of the key 50A of “M” of the pre-modification character.

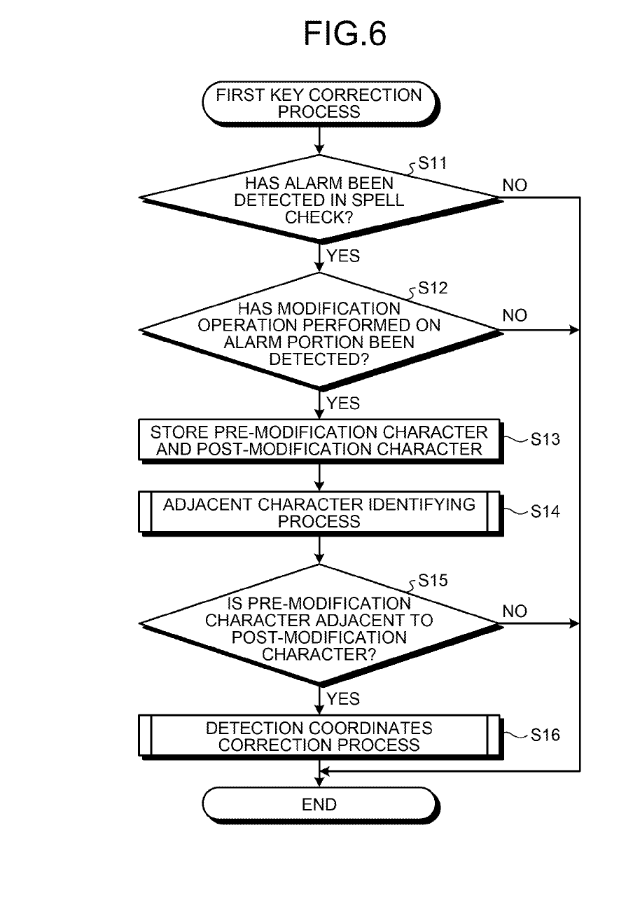

In the following, the operation of the information terminal device 1 according to the first embodiment will be described. FIG. 6 is a flowchart illustrating an example of the flow of a first key correction process performed by the processor 53 in the information terminal device 1. The first key correction process illustrated in FIG. 6 is a correction process that extends the detection coordinates of the key 50A of the post-modification character in the arrangement direction of the key 50A of the pre-modification character when modification of an input character is detected by a spell check function and when the key 50A of the pre-modification character is adjacent to the key 50A of the post-modification character.

In FIG. 6, the detecting unit 53B in the processor 53 determines whether an alarm has been detected by the spell check function (Step S11). The alarm mentioned here is an alarm indicating that an error character has been detected by the spell check function. If the input unit 53A in the processor 53 has detected an alarm (Yes at Step S11), the determining unit 53C determines whether a modification operation performed on an alarm portion has been detected (Step S12).

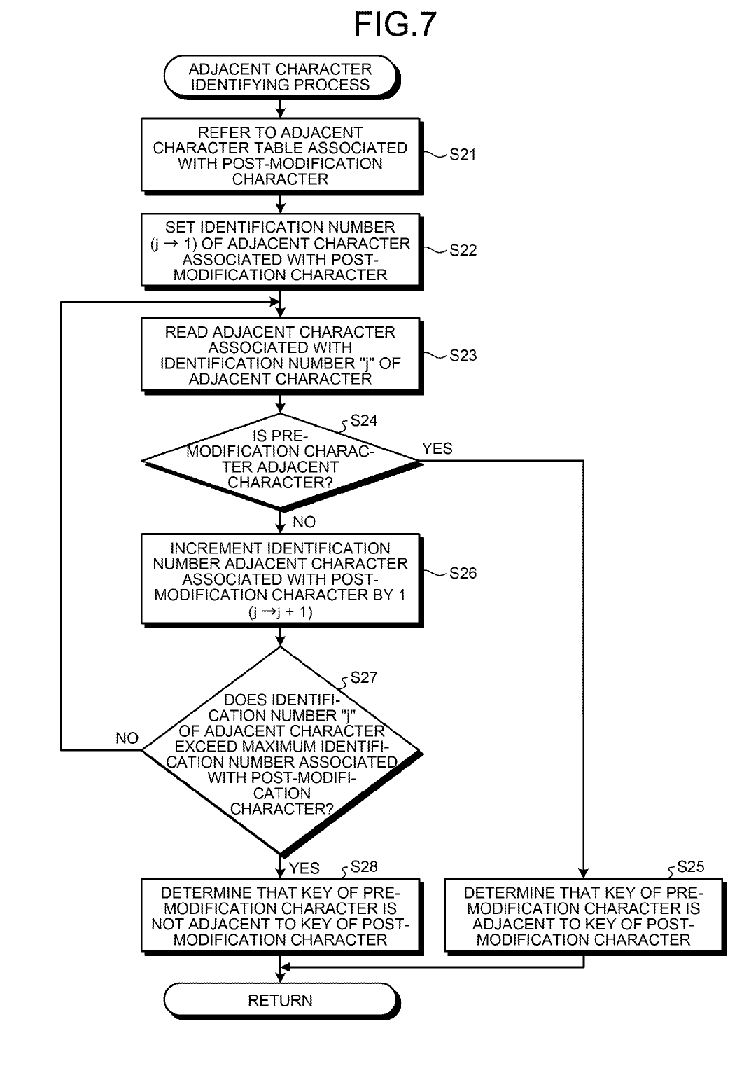

If the determining unit 53C in the processor 53 determines that the modification operation performed on the alarm portion has been detected (Yes at Step S12), the determining unit 53C stores both the pre-modification character and the post-modification character in a work area in the memory 52 (Step S13) and executes the adjacent character identifying process illustrated in FIG. 7 (Step S14).

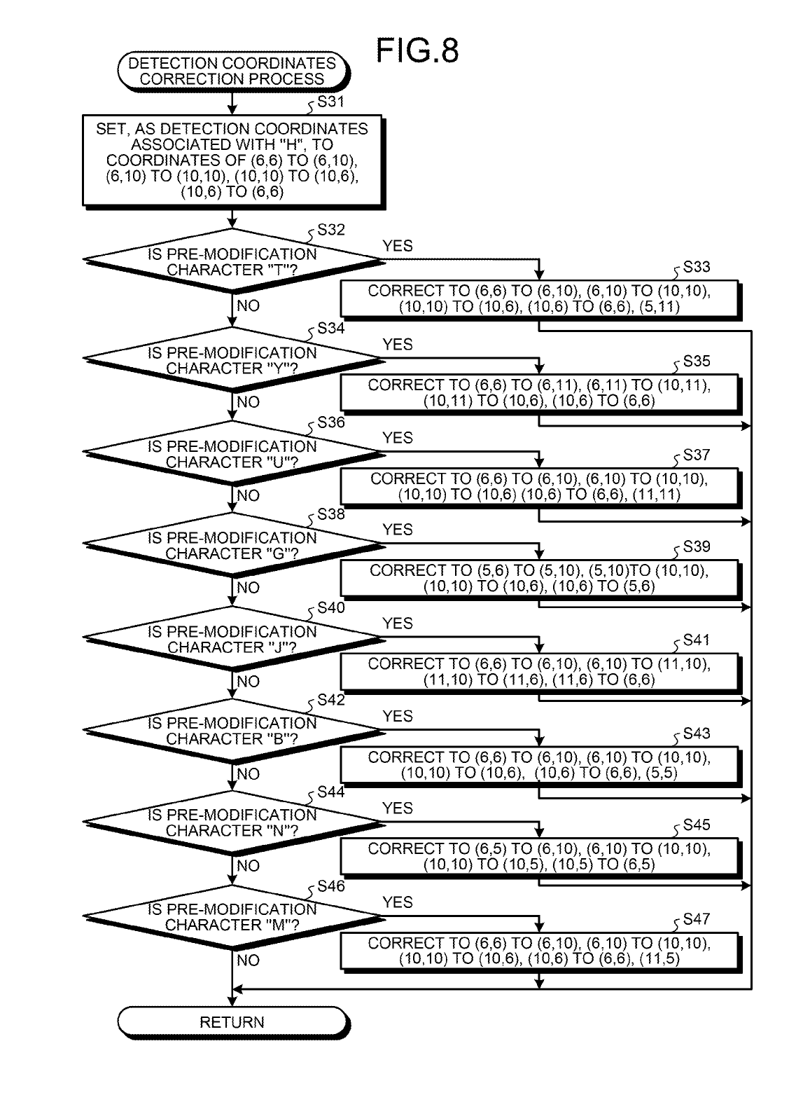

After the determining unit 53C executes the adjacent character identifying process, the determining unit 53C determines whether the key 50A of the pre-modification character is adjacent to the key 50A of the post-modification character (Step S15). Then, the determining unit 53C refers to the adjacent character table 62 illustrated in FIG. 4. If the key 50A of the pre-modification character is adjacent to the key 50A of the post-modification character (Yes at Step S15), the determining unit 53C executes the detection coordinates correction process illustrated in FIG. 8 (Step S16) and ends the operation for the process illustrated in FIG. 6.

If an alarm has not been detected by the spell check function (No at Step S11), the processor 53 ends the operation for the process illustrated in FIG. 6. If the modification operation performed on the alarm portion has not been detected (No at Step S12), the processor 53 ends the operation for the process illustrated in FIG. 6. If the key 50A of the pre-modification character is not adjacent to the key 50A of the post-modification character (No at Step S15), the determining unit 53C ends the operation for the process illustrated in FIG. 6.

In the first key correction process, the processor 53 modifies an input character by using the spell check function. If the key 50A of the pre-modification character is adjacent to the key 50A of the post-modification character, the processor 53 extends the detection coordinates of the key 50A of the post-modification character in the detection area 50B in the arrangement direction of the key 50A of the pre-modification character. Consequently, because the detection coordinates of the key 50A of the post-modification character is extended in the arrangement direction of the key 50A of the pre-modification character, the information terminal device 1 can suppresses an erroneous operation performed on the key 50A of the post-modification character and thus can improve the input accuracy.

FIG. 7 is a flowchart illustrating an example of the flow of an adjacent character identifying process performed by the processor 53. The adjacent character identifying process illustrated in FIG. 7 is a process for determining whether the key 50A of the pre-modification character is the key 50A of the adjacent character that is adjacent to the key 50A of the post-modification character.

In FIG. 7, the determining unit 53C in the processor 53 refers to the adjacent character table 62 (Step S21) and sets the identification number 62C of the adjacent character 62B that is associated with the post-modification character 62A to “j→1” (Step S22). The determining unit 53C reads the adjacent character 62B that is associated with “j” of the identification number 62C from the adjacent character table 62 (Step S23) and then determines whether the pre-modification character is the read adjacent character (Step S24).

If the pre-modification character is an adjacent character (Yes at Step S24), the determining unit 53C determines that the key 50A of the pre-modification character is adjacent to the key 50A of the post-modification character (Step S25) and ends the operation for the process illustrated in FIG. 7.

If the pre-modification character is not the adjacent character (No at Step S24), the determining unit 53C increments the identification number 62C of the adjacent character 62B associated with the post-modification character 62A by 1 and make the status to “j→j+1” (Step S26). The determining unit 53C determines whether the identification number “j” of the adjacent character 62B exceeds the maximum identification number associated with the post-modification character (Step S27). As illustrated in FIG. 4, if the post-modification character is “H”, the maximum identification number is “8”. In other words, in the case of the post-modification character of “H”, the number of adjacent characters is “8” that is indicated by the maximum identification number.

If the identification number “j” of the adjacent character 62B exceeds the maximum identification number of the post-modification character (Yes at Step S27), the determining unit 53C determines that the key 50A of the pre-modification character is not adjacent to the key 50A of the post-modification character (Step S28) and ends the operation of the process illustrated in FIG. 7.

In the adjacent character identifying process illustrated in FIG. 7, the processor 53 refers to the adjacent character table 62 that is associated with the post-modification character. If the pre-modification character is within the adjacent character of the post-modification character, the processor 53 determines that the key 50A of the pre-modification character is adjacent to the key 50A of the post-modification character. Consequently, the processor 53 can identify whether the key 50A of the pre-modification character is adjacent to the key 50A of the post-modification character.

FIG. 8 is a flowchart illustrating an example of the flow of the detection coordinates correction process performed by the processor 53. The detection coordinates correction process illustrated in FIG. 8 is a correction process that extends the detection coordinates in the detection area 50B that is associated with the key 50A of the post-modification character in the arrangement direction of the key 50A of the pre-modification character.

In FIG. 8, the correcting unit 53D in the processor 53 sets, as an initial value, the detection coordinates associated with the key 50A of “H” to the coordinates of (6,6) to (6,10), (6,10) to (10,10), (10, 10) to (10,6), (10,6) to (6,6) (Step S31). After the detection coordinates are set, the correcting unit 53D determines whether the pre-modification character is the character “T” that is adjacent to the key 50A of the post-modification character of “H” (Step S32). If the pre-modification character is the character “T” adjacent to character “H” (Yes at Step S32), the correcting unit 53D corrects the detection coordinates of the key 50A of the post-modification character “H” to the coordinates of (6,6) to (6,10), (6, 10) to (10,10), (10,10) to (10,6), (10,6) to (6,6), (5,11) (Step S33) and then ends the operation of the process illustrated in FIG. 8. Consequently, the detection coordinates of the key 50A of the post-modification character “H” is extended in the arrangement direction of the key 50A of the adjacent character “T”.

If the pre-modification character is not the adjacent character “T” (No at Step S32), the correcting unit 53D determines whether the pre-modification character is the character “Y” that is adjacent to the key 50A of the post-modification character “H” (Step S34). If the pre-modification character is the character “Y” that is adjacent to the key 50A of the post-modification character “H” (Yes at Step S34), the correcting unit 53D corrects the detection coordinates of the key 50A of the post-modification character “H” to the coordinates of (6,6) to (6,11), (6,11) to (10,11), (10,11) to (10,6), (10,6) to (6,6) (Step S35). Then, the processor 53 ends the operation of the process illustrated in FIG. 8. Consequently, the detection coordinates of the key 50A of the post-modification character “H” is extended in the arrangement direction of the key 50A of the adjacent character “Y”.

If the pre-modification character is not the adjacent character “Y” (No at Step S34), the correcting unit 53D determines whether the pre-modification character is the character “U” that is adjacent to the key 50A of the post-modification character “H” (Step S36). If the pre-modification character is the character “U” that is adjacent to the key 50A of the post-modification character “H” (Yes at Step S36), the correcting unit 53D corrects the detection coordinates of the key 50A of the post-modification character “H” to the coordinates of (6,6) to (6,10), (6,10) to (10,10), (10,10) to (10,6), (10,6) to (6,6), (11,11) (Step S37). Then, the processor 53 ends the operation of the process illustrated in FIG. 8. Consequently, the detection coordinates of the key 50A of the post-modification character “H” is extended in the arrangement direction of the key 50A of the adjacent character “U”.

If the pre-modification character is not the adjacent character “U” (No at Step S36), the correcting unit 53D determines whether the pre-modification character is the character “G” that is adjacent to the key 50A of the post-modification character “H” (Step S38). If the pre-modification character is the character “G” that is adjacent to the key 50A of the post-modification character “H” (Yes at Step S38), the correcting unit 53D corrects the detection coordinates of the key 50A of the post-modification character “H” to the coordinates of (5,6) to (5,10), (5,10) to (10,10), (10,10) to (10,6), (10,6) to (5,6) (Step S39). Then, the processor 53 ends the operation of the process illustrated in FIG. 8. Consequently, the detection coordinates of the key 50A of the post-modification character “H” is extended in the arrangement direction of the key 50A of the adjacent character “G”.

If the pre-modification character is not the character “G” that is adjacent to the key 50A of the post-modification character “H” (No at Step S38), the correcting unit 53D determines whether the pre-modification character is the character “J” that is adjacent to the key 50A of the post-modification character “H” (Step S40). If the pre-modification character is the character “J” that is adjacent to the key 50A of the post-modification character “H” (Yes at Step S40), the correcting unit 53D corrects the detection coordinates of the key 50A of the post-modification character “H” to the coordinates of (6,6) to (6,10), (6, 10) to (11,10), (11, 10) to (11,6), (11,6) to (6,6) (Step S41). Then, the processor 53 ends the operation of the process illustrated in FIG. 8. Consequently, the detection coordinates of the key 50A of the post-modification character “H” is extended in the arrangement direction of the key 50A of the adjacent character “J”.

If the pre-modification character is not the character “J” that is adjacent to the key 50A of the post-modification character “H” (No at Step S40), the correcting unit 53D determines whether the pre-modification character is the character “B” that is adjacent to the key 50A of the post-modification character “H” (Step S42). If the pre-modification character is the character “B” that is adjacent to the key 50A of the post-modification character “H” (Yes at Step S42), the correcting unit 53D corrects the detection coordinates of the key 50A of the post-modification character “H” to the coordinates of (6,6) to (6,10), (6, 10) to (10,10), (10,10) to (10,6), (10,6) to (6,6), (5,5) (Step S43). Then, the processor 53 ends the operation of the process illustrated in FIG. 8. Consequently, the detection coordinates of the key 50A of the post-modification character “H” is extended in the arrangement direction of the key 50A of the adjacent character “B”.

If the pre-modification character is not the character “B” that is adjacent to the key 50A of the post-modification character “H” (No at Step S42), the correcting unit 53D determines whether the pre-modification character is the character “N” that is adjacent to the key 50A of the post-modification character “H” (Step S44). If the pre-modification character is the character “N” that is adjacent to the key 50A of the post-modification character “H” (Yes at Step S44), the correcting unit 53D corrects the detection coordinates of the key 50A of the post-modification character “H” to the coordinates of (6,5) to (6,10), (6, 10) to (10,10), (10,10) to (10,5), (10,5) to (6,5) (Step S45). Then, the processor 53 ends the operation for the process illustrated in FIG. 8. Consequently, the detection coordinates of the key 50A of the post-modification character “H” is extended in the arrangement direction of the key 50A of the adjacent character “N”.

If the pre-modification character is not the character “N” that is adjacent to the key 50A of the post-modification character “H” (No at Step S44), the correcting unit 53D determines whether the pre-modification character is the character “M” that is adjacent to the key 50A of the post-modification character “H” (Step S46). If the pre-modification character is the character “M” that is adjacent to the key 50A of the post-modification character “H” (Yes at Step S46), the correcting unit 53D corrects detection coordinates of the key 50A of the post-modification character “H” to the coordinates of (6,6) to (6,10), (6, 10) to (10,10), (10,10) to (10,6), (10,6) to (6,6), (11,5) (Step S47). Then, the processor 53 ends the operation for the process illustrated in FIG. 8. Consequently, the detection coordinates of the key 50A of the post-modification character “H” is extended in the arrangement direction of the key 50A of the adjacent character “M”.

In the detection coordinates correction process illustrated in FIG. 8, if the pre-modification character is a character that is adjacent to the key 50A of the post-modification character, the detection coordinates of the key 50A of the post-modification character is extended in the arrangement direction of the key 50A of the pre-modification character. Consequently, the user can suppress the erroneous operation performed on the key 50A of the post-modification character.

In the detection coordinates correction process illustrated in FIG. 8, a description has been given of a case, as an example, in which the post-modification character is “H”; however, the character is not limited to “H”. For example, the detection coordinates of the key 50A of the post-modification character may also be extended in the arrangement direction of the adjacent key 50A of the pre-modification character.

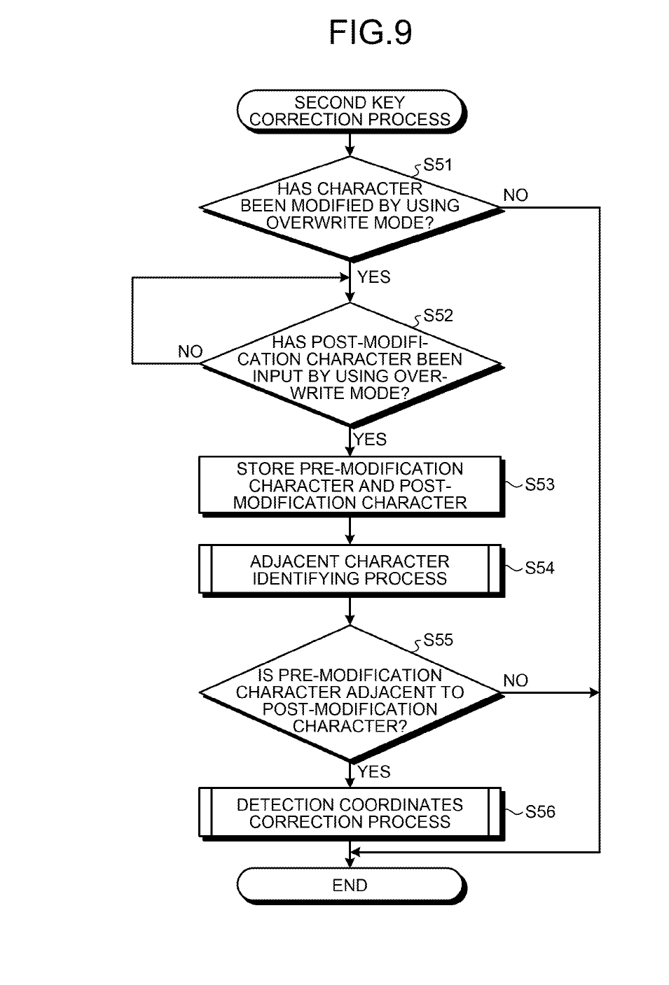

Furthermore, in the first key correction process illustrated in FIG. 6, a description has been given of a case, as an example, in which a character is modified by using the spell check function; however, the same is applied to a case in which, for example, a character is modified by using an overwrite mode. Accordingly, in the following, a description will be given of a case in which a key correction process is performed when a character is modified by using the overwrite mode. FIG. 9 is a flowchart illustrating an example of the flow of a second key correction process performed by the processor 53. The second key correction process illustrated in FIG. 9 is a correction process for extending the detection coordinates of the key 50A of the post-modification character when it is detected that an input character is modified by using the overwrite mode and when the key 50A of the pre-modification character is adjacent to the key 50A of the post-modification character.

In FIG. 9, the detecting unit 53B determines whether a character modification performed by using the overwrite mode has been detected (Step S51). If the input unit 53A detects that the character modification has been performed by using the overwrite mode (Yes at Step S51), the determining unit 53C determines whether an input of a post-modification character performed by using the overwrite mode has been detected (Step S52).

If the determining unit 53C has detected an input of a post-modification character performed by using the overwrite mode (Yes at Step S52), the determining unit 53C stores both the pre-modification character and the post-modification character in a work area in the memory 52 (Step S53) and executes the adjacent character identifying process illustrated in FIG. 7 (Step S54).

After the determining unit 53C executes the adjacent character identifying process, the determining unit 53C determines whether the key 50A of the pre-modification character is adjacent to the key 50A of the post-modification character (Step S55). If the key 50A of the pre-modification character is adjacent to the key 50A of the post-modification character (Yes at Step S55), the determining unit 53C executes the detection coordinates correction process illustrated in FIG. 8 (Step S56) and ends the operation for the process illustrated in FIG. 9.

If a character modification performed by using the overwrite mode has not been detected (No at Step S51), the processor 53 ends the operation for the process illustrated in FIG. 9. If the character modification performed by using the overwrite mode has been detected (No at Step S52), the processor 53 proceeds to Step S52 in order to determine whether an input of a post-modification character has been detected. If the key 50A of the pre-modification character is adjacent to the key 50A of the post-modification character (No at Step S55), the determining unit 53C ends the operation for the process illustrated in FIG. 9.

If the key 50A of the pre-modification character using the overwrite mode is adjacent to the key 50A of the post-modification character, the processor 53 that performs the second key correction process illustrated in FIG. 9 extends the detection coordinates of the key 50A of the post-modification character in the arrangement direction of the key 50A of the pre-modification character. Consequently, because the detection coordinates of the key 50A of the post-modification character is extended in the arrangement direction of the key 50A of the pre-modification character, a user of the information terminal device 1 can suppresses an erroneous operation performed on the key 50A of the post-modification character and thus can improve the input accuracy.

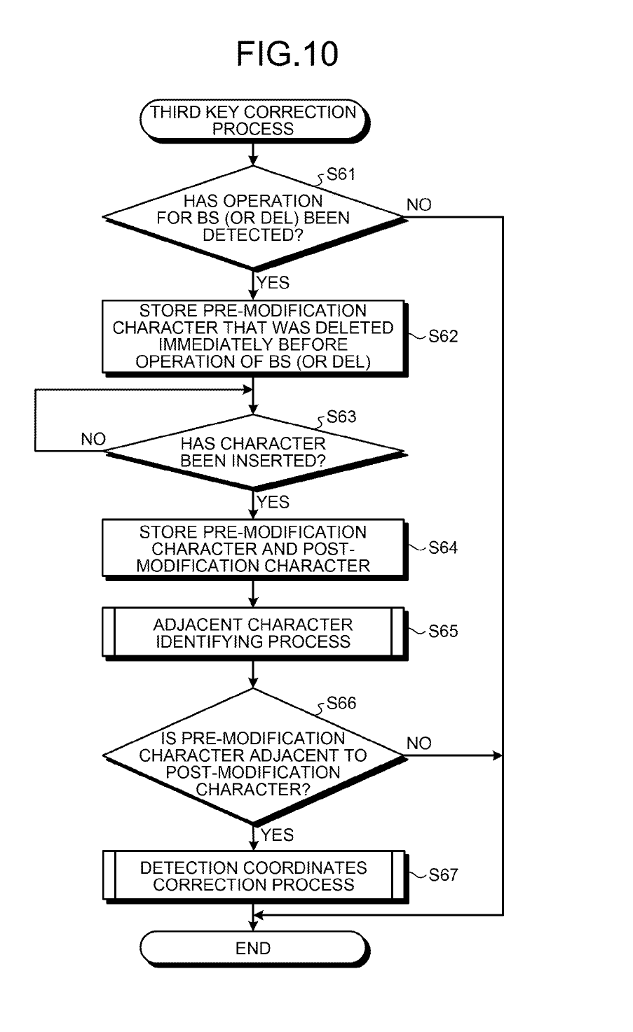

In the following, a description will be given of a key correction process for modifying a character, which is performed when a character is modified by using a delete key, such as the backspace (BS) key, the delete (DEL) key, or the like, i.e., when a character is deleted by using the delete key and then another character is inserted. FIG. 10 is a flowchart illustrating an example of the flow of a third key correction process performed by the processor 53. The third key correction process illustrated in FIG. 10 is a correction process that extends the detection coordinates of the key 50A of a post-modification character when input a character modification, in which an existing character is deleted by using the delete key and a new character is inserted, is detected and when the key 50A of the pre-modification character is adjacent to the key 50A of the post-modification character.

In FIG. 10, the detecting unit 53B determines whether an operation of the delete key has been detected (Step S61). If the detecting unit 53B has detected the operation of the delete key (Yes at Step S61), the detecting unit 53B stores the pre-modification character that was deleted immediately before the operation of the delete key in a work area in the memory 52 (Step S62). After the pre-modification character is deleted, the determining unit 53C determines whether an insertion of a character has been detected (Step S63).

If the determining unit 53C has detected an insertion of a character (Yes at Step S63), the determining unit 53C stores, in a work area in the memory 52, the post-modification character that is inserted by associating it with the pre-modification character (Step S64) and executes the adjacent character identifying process illustrated in FIG. 7 (Step S65).

After the determining unit 53C executes the adjacent character identifying process, the determining unit 53C determines whether the key 50A of the pre-modification character is adjacent to the key 50A of the post-modification character (Step S66). If the key 50A of the pre-modification character is adjacent to the key 50A of the post-modification character (Yes at Step S66), the determining unit 53C executes the detection coordinates correction process illustrated in FIG. 8 (Step S67) and ends the operation for the process illustrated in FIG. 10.

If the processor 53 has not detected an operation of the delete key (No at Step S61), the processor 53 ends the operation for the process illustrated in FIG. 10. If the processor 53 has not detected an insertion of a character (No at Step S63), the processor 53 proceeds to Step S63 in order to determine whether an insertion of a character has been detected. If the key 50A of a pre-modification character is not adjacent to the key 50A of the post-modification character (No at Step S66), the determining unit 53C ends the operation for the process illustrated in FIG. 10.

When a character modification, in which an existing character is deleted by using the delete key and a new character is inserted, is performed, if the key 50A of a pre-modification character is adjacent to the key 50A of a post-modification character, the processor 53 that performs the third key correction process extends the detection coordinates of the key 50A of the post-modification character in the arrangement direction of the key 50A of the pre-modification character. Consequently, because the information terminal device 1 extends detection coordinates of the key 50A of the post-modification character in the arrangement direction of the key 50A of the pre-modification character, the information terminal device 1 can suppresses an erroneous operation performed on the key 50A of the post-modification character and thus can improve the input accuracy.

When the information terminal device 1 according to the first embodiment detects a character modification, if the key 50A of a pre-modification character is adjacent to the key 50A of a post-modification character, the information terminal device 1 extends the detection coordinates of the key 50A of the post-modification character in the arrangement direction of the key 50A of the pre-modification character. Consequently, because the information terminal device 1 extends the detection coordinates of the key 50A of the post-modification character in the arrangement direction of the key 50A of the pre-modification character, the information terminal device 1 can suppresses an erroneous operation performed on the key 50A of the post-modification character and thus can improve the input accuracy. Furthermore, because the information terminal device 1 corrects the detection coordinates of the key 50A in the detection area 50B by taking into considering a user's habit of the erroneous operation, the information terminal device 1 can provide the software keyboard 50 with a detection area suitable for the user.

Furthermore, by repeatedly performing the extending and the reducing of the area of the detection coordinates of the key 50A in accordance with a character modification, the information terminal device 1 can provide the software keyboard 50 suitable for a user.

Furthermore, in the first embodiment described above, if the key 50A of a pre-modification character is adjacent to the key 50A of a post-modification character, the detection coordinates of the key 50A of the post-modification character is extended in the arrangement direction of the key 50A of the pre-modification character. However, if the number of determinations in which the key 50A of the pre-modification character is adjacent to the key 50A of the post-modification character, i.e., if the number of modifications in which a pre-modification character is modified to an adjacent post-modification character, exceeds a predetermined number of times, it may also possible to extend the detection coordinates of the key 50A of the post-modification character. Accordingly, such a case will be described as a second embodiment below.

### [b] Second Embodiment

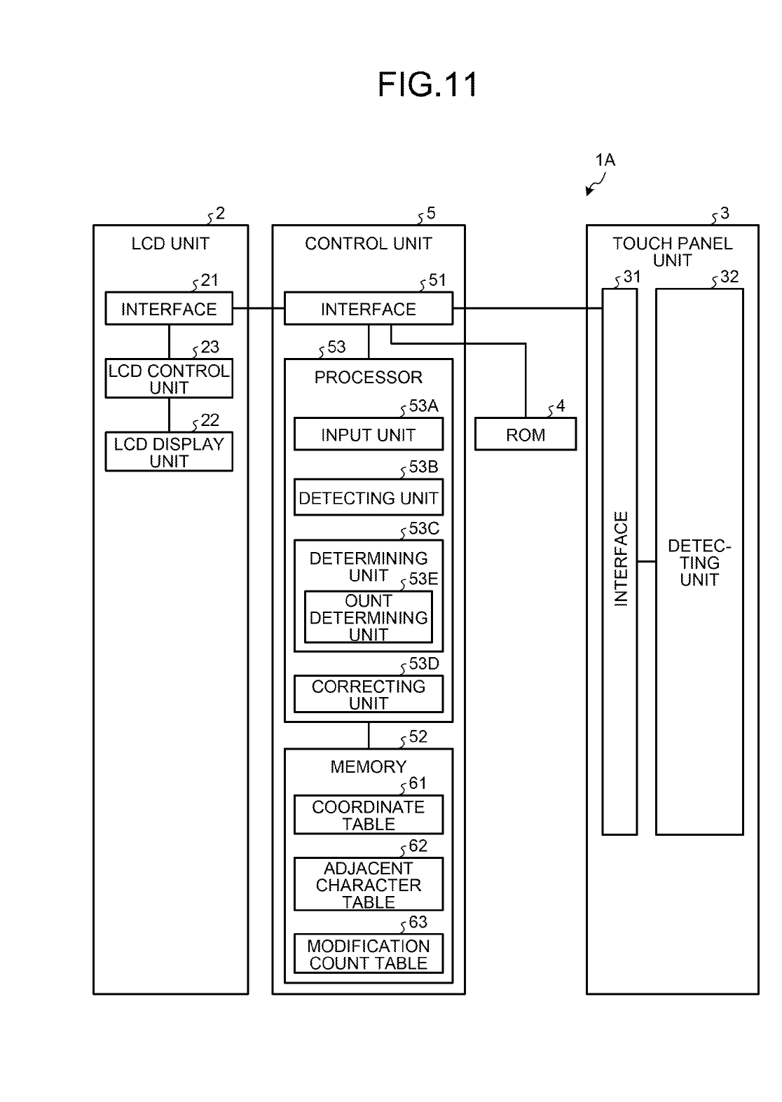

FIG. 11 is a block diagram illustrating an example of the configuration of an information terminal device 1A according to a second embodiment. Components having the same configuration as those in the information terminal device 1 illustrated in FIG. 1 are assigned the same reference numerals and descriptions of such components in detail are omitted. If the key 50A of a pre-modification character is adjacent to the key 50A of a post-modification character, a count determining unit 53E in the determining unit 53C in the processor 53 in the control unit 5 in the information terminal device 1A illustrated in FIG. 11 counts a modification count by associating a pre-modification character with a post-modification character. Furthermore, the memory 52 in the control unit 5 stores therein a modification count table 63 that stores therein a modification count in which a pre-modification character is associated with a post-modification character.

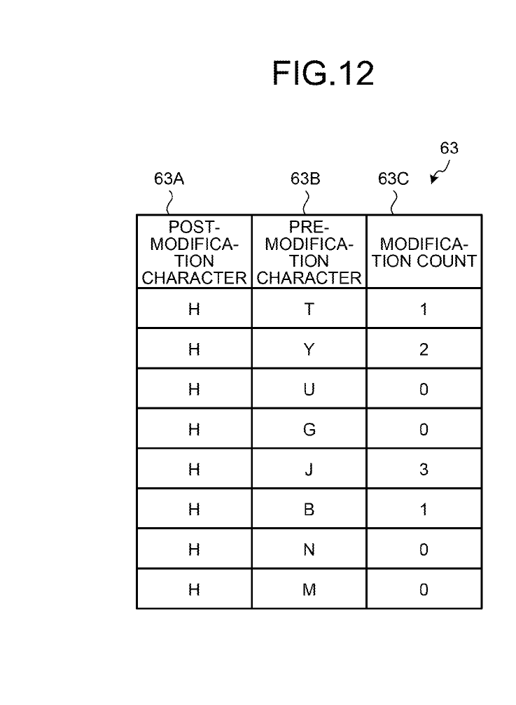

FIG. 12 is a schematic diagram illustrating an example of the modification count table 63. The modification count table 63 stores therein, in an associated manner, a post-modification character 63A, a pre-modification character 63B, and a modification count 63C. The pre-modification character 63B is a character that is associated with the key 50A adjacent to the key 50A of a post-modification character. The modification count 63C is the number of modifications is performed on the combination of a pre-modification character and a post-modification character. The processor 53 refers to the modification count table 63 and can recognize that, for example, the modification count 63C in which the pre-modification character 63B of “T” is modified to the post-modification character 63A of “H” is “once”. Furthermore, the processor 53 refers to the modification count table 63 and can recognize that, for example, the modification count 63C in which the pre-modification character 63B of “Y” is modified to the post-modification character 63A of “H” is “twice”. Furthermore, the processor 53 refers to the modification count table 63 and can recognize that, for example, the modification count 63C in which the pre-modification character 63B of “J” is modified to the post-modification character 63A of “H” is “three times”.

The count determining unit 53E refers to the modification count table 63 and determines whether the modification count 63C that is associated with the combination of the post-modification character 63A and the pre-modification character 63B exceeds a predetermined number of times. Furthermore, the predetermined number of times mentioned here is set to, for example, two. If the modification count 63C that is associated with the combination of the post-modification character 63A and the pre-modification character 63B exceeds the predetermined number of times, the correcting unit 53D extends the detection coordinates of the key 50A of the post-modification character in the arrangement direction of the key 50A of the pre-modification character.

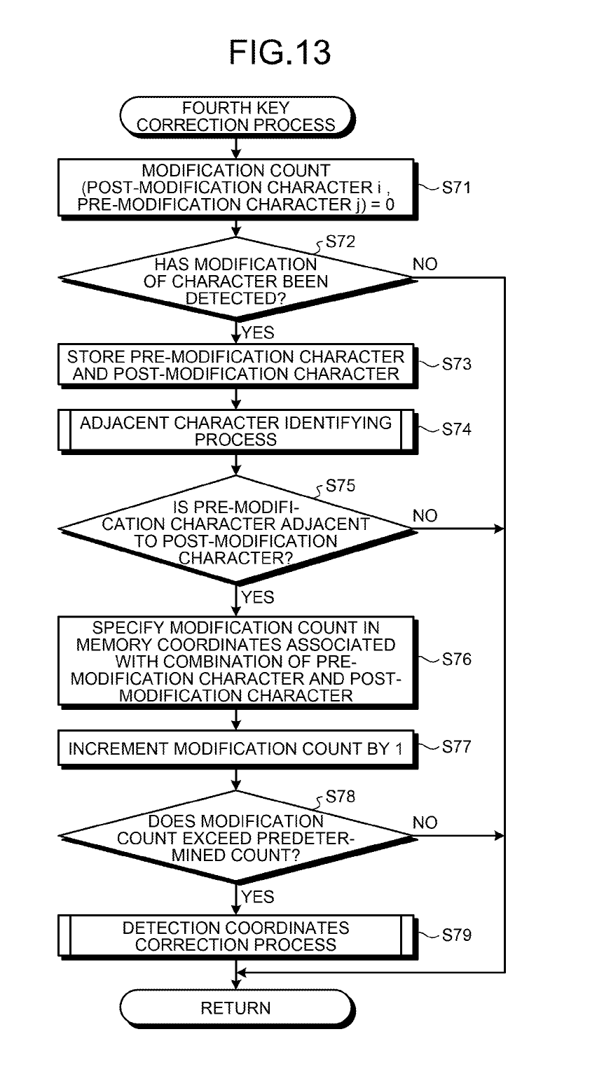

In the following, a description will be given of an operation of the information terminal device 1A according to the second embodiment. FIG. 13 is a flowchart illustrating an example of the flow of a fourth key correction process performed by the processor 53 in the information terminal device 1A. The fourth key correction process illustrated in FIG. 13 is a correction process that extends the detection coordinates of the key 50A of a post-modification character in the arrangement direction of the key 50A of a pre-modification character, if a modification count in which a pre-modification character is modified to an adjacent post-modification character and if the modification count exceeds the predetermined number of times.

In FIG. 13, the processor 53 clears the content of the modification count table 63 (Step S71). The detecting unit 53B in the processor 53 determines whether a character modification has been detected (Step S72). If the input unit 53A in the processor 53 has detected a character modification (Yes at Step S72), the input unit 53A stores the pre-modification character and the post-modification character in the modification count table 63 (Step S73) and executes the adjacent character identifying process illustrated in FIG. 7 (Step S74).

After the determining unit 53C in the processor 53 executes the adjacent character identifying process, the determining unit 53C determines whether the key 50A of the pre-modification character is adjacent to the key 50A of the post-modification character (Step S75). If the key 50A of the pre-modification character is adjacent to the key 50A of the post-modification character (Yes at Step S75), the determining unit 53C specifies the modification count 63C, in the modification count table 63, that is associated with the combination of the pre-modification character 63B and the post-modification character 63A (Step S76). Then, the determining unit 53C increments the specified modification count 63C by 1 (Step S77).

After the count determining unit 53E in the processor 53 increments the modification count by 1 (Step S77), the count determining unit 53E determines whether the modification count exceeds the predetermined number of times (Step S78). The predetermined number of times mentioned here is set to, for example, two. If the modification count exceeds the predetermined number of times (Yes at Step S78), the count determining unit 53E in the processor 53 executes the detection coordinates correction process illustrated in FIG. 8 (Step S79) and ends the operation for the process illustrated in FIG. 13.

If the processor 53 has not detected a character modification (No at Step S72), the processor 53 ends the operation for the process illustrated in FIG. 13. If the key 50A of the pre-modification character is not adjacent to the key 50A of the post-modification character (No at Step S75), the processor 53 ends the operation for the process illustrated in FIG. 13.

If the modification count that is associated with the combination of the pre-modification character and the post-modification character does not exceed the predetermined number of times (No at Step S78), the processor 53 ends the operation for the process illustrated in FIG. 13.

The processor 53 that performs the fourth key correction process illustrated in FIG. 13 counts the number of times a pre-modification character has been modified to an adjacent post-modification character and then determines whether the modification count in which the pre-modification character has been modified to the post-modification character exceeds the predetermined number of times. If the number of times a pre-modification character has been modified to a post-modification character exceeds the predetermined number of times, the processor 53 extends the detection coordinates of the key 50A of the post-modification character in the arrangement direction of the key 50A of the pre-modification character. Consequently, in accordance with the number of times a pre-modification character has been modified to a post-modification character, the information terminal device 1A can reduce the number of times the detection coordinates of the key 50A of a post-modification character is extended.

The information terminal device 1A according to the second embodiment counts the number of times a pre-modification character has been modified to an adjacent post-modification character. If the number of times the pre-modification character has been modified to the post-modification character exceeds the predetermined number of times, the information terminal device 1A extends the detection coordinates of the key 50A of the post-modification character in the arrangement direction of the key 50A of the pre-modification character. Consequently, in accordance with the number of times a pre-modification character has been modified to a post-modification character, the information terminal device 1A can reduce the number of times the detection coordinates of the key 50A of a post-modification character is extended. Specifically, it is possible to avoid a case in which the detection coordinates of the key 50A is extended every time a user accidentally performs an erroneous operation.

Furthermore, the information terminal device 1A can suppresses an erroneous operation performed on the key 50A of the post-modification character and thus can improve the input accuracy. Furthermore, because the information terminal device 1 corrects the detection coordinates of the key 50A in the detection area 50B by taking into considering a user's habit of the erroneous operation, the information terminal device 1 can provide the software keyboard 50 with a detection area suitable for the user. Furthermore, by repeatedly performing the extending and the reducing of the area of the detection coordinates of the key 50A in accordance with a character modification, the information terminal device 1 can provide the software keyboard 50 suitable for a user.

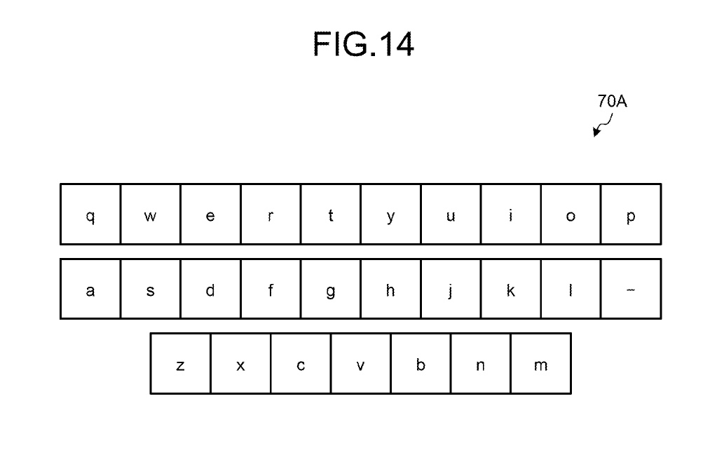

FIG. 14 is a schematic diagram illustrating an example of a layout screen of a software keyboard with QWERTY layout. The information terminal device 1 (1A) according to the embodiments may also be used for, for example, a software keyboard 70A with the QWERTY layout illustrated in FIG. 14.

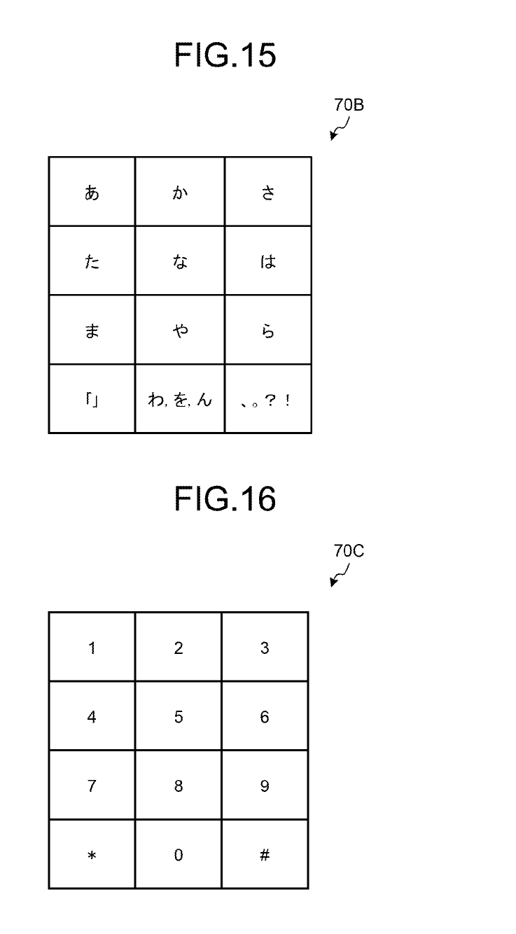

FIG. 15 is a schematic diagram illustrating an example of a layout screen of a software keyboard with Japanese Kana characters. FIG. 16 is a schematic diagram illustrating an example of a layout screen of a software keyboard with a numeric keypad. The information terminal device 1 (1A) according to the embodiments may also be used for a software keyboard 70B with the Japanese Kana character layout illustrated in FIG. 15 of a software keyboard 70C with a numeric keypad layout illustrated in FIG. 16.

In the embodiments described above, the information terminal device 1 (1A) is used as an example; however, the embodiments are not limited thereto. For example, any terminal device may also be used as long as it includes the software keyboard 50 with a touch panel function. For example, a terminal device, such as a smart phone, a tablet device, a personal computer, or the like may also be used.

The components of each unit illustrated in the drawings are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, all or any part of the processing functions performed by each unit may also be executed by a central processing unit (CPU) (or a microcomputer, such as a micro processing unit (MPU) or a micro controller unit (MCU)). Furthermore, all or any part of the processing functions may also be executed by programs analyzed and executed by the CPU (or the microcomputer, such as the MPU or the MCU) or executed by hardware by wired logic.

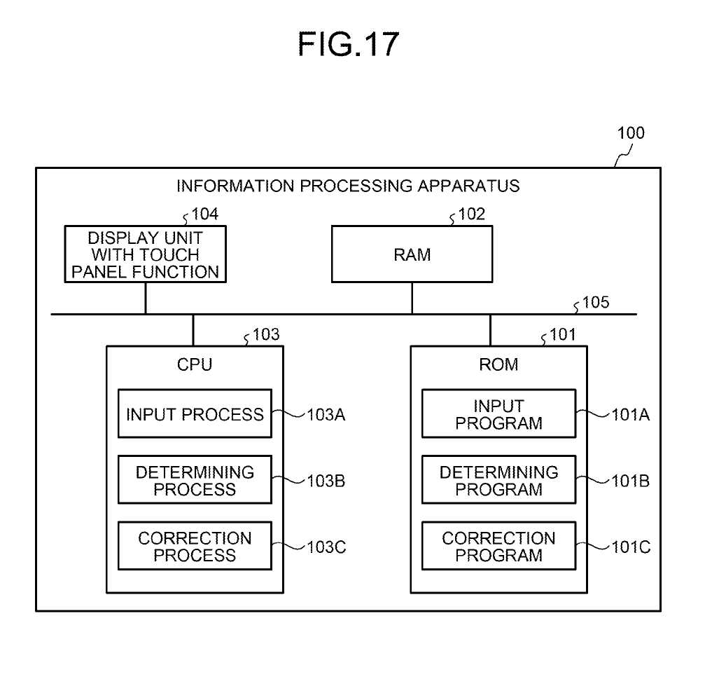

Various kinds of processes described in the above embodiments can be implemented by programs prepared in advance and executed by a processor, such as a CPU in an information processing apparatus. Accordingly, in the following, an information processing apparatus that executes programs having the same function as those described in the embodiments described above will be described as an example. FIG. 17 is a block diagram illustrating an example of an information processing apparatus that executes a key correction program.

An information processing apparatus 100 that executes a key correction program illustrated in FIG. 17 includes a read only memory (ROM) 101, a random access memory (RAM) 102, a CPU 103, and a display unit 104 with a touch panel function. Furthermore, in the information processing apparatus 100, the ROM 101, the RAM 102, the CPU 103, and the display unit 104 with the touch panel function are connected via a bus 105.

The ROM 101 stores therein, in advance, a key display program having the same function as that in the embodiment. Instead of the ROM 101, the key display program may also be stored in a computer readable recording medium by using a drive (not illustrated). Furthermore, the recording medium may also be, for example, a portable recording medium, such as a CD-ROM, a DVD disk, a USB memory, or the like, or a semiconductor memory, such as a flash memory. Furthermore, the key display program may also appropriately be separated and be stored in the CPU 103.

The CPU 103 reads an input program 101A from the ROM 101 and functions as an input process 103A. Furthermore, the CPU 103 reads a determining program 101B from the ROM 101 and functions as a determining process 103B. Furthermore, the CPU 103 reads a correction program 101C from the ROM 101 and functions as a correction process 103C.

When the CPU 103 detects a touch operation in a detection area that is associated with each of the keys of the software keyboard on the display unit 104 that has a touch panel function, the CPU 103 inputs a character that is associated with one of the keys in the corresponding detection area. If the CPU 103 detects a modification of an input character, the CPU 103 determines whether the key of a pre-modification character is adjacent to the key of a post-modification character on the keyboard layout. If the key of the pre-modification character is adjacent to the key of the post-modification character, the CPU 103 extends the detection area of the key that is associated with the post-modification character in the arrangement direction of the key that is associated with the pre-modification character. Consequently, because the information processing apparatus 100 extends the detection coordinates of the key of the post-modification character in the arrangement direction of the key of the pre-modification character, the information processing apparatus 100 can suppresses an erroneous operation performed on an adjacent key on the software keyboard and thus can improve the input accuracy.

According to an aspect of an embodiment of the present invention, an advantage is provided in that the input accuracy of an adjacent key on a software keyboard can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information terminal device comprising:
an input unit that inputs, when an operation for specifying a detection area that is associated with one of keys on a software keyboard that is displayed on a screen has been detected, a character associated with the key in the detection area;
a determining unit that determines, when a modification of the character input by the input unit has been detected, whether the key of the pre-modification character is adjacent to a key of a post-modification character in the layout of the software keyboard; and
a correcting unit that extends, when the determining unit determines that the key of the pre-modification character is adjacent to the key of the post-modification character, the detection area of the key that is associated with the post-modification character in the arrangement direction of the key that is associated with the pre-modification character.

2. The information terminal device according to claim 1, wherein
the determining unit includes a count determining unit that counts, when the determining unit determines that the key of the pre-modification character is adjacent to the key of the post-modification character, the number of determinations associated with a combination of the pre-modification character and the post-modification character and that determines whether the number of determinations exceeds a predetermined value, and
when the count determining unit determines that the number of determinations exceeds the predetermined value, the correcting unit extends, in the arrangement direction of the key that is associated with the pre-modification character, the detection area of the key that is associated with the post-modification character that has been determined that the number of determinations exceeds the predetermined value.

3. A key correction method comprising:
inputting, performed by an information terminal device, when an operation for specifying a detection area that is associated with one of keys on a software keyboard that is displayed on a screen has been detected, a character associated with the key in the detection area;
determining, performed by the information terminal device, when a modification of the character that was input at the inputting has been detected, whether the key of the pre-modification character is adjacent to a key of a post-modification character in the layout of the software keyboard; and
extending, performed by the information terminal device, when it is determined at the determining that the key of the pre-modification character is adjacent to the key of the post-modification character, the detection area of the key that is associated with the post-modification character in the arrangement direction of the key that is associated with the pre-modification character.

4. A computer-readable, non-transitory medium having stored therein a key correction program causing a computer to execute a process comprising:
inputting, when an operation for specifying a detection area that is associated with one of keys on a software keyboard that is displayed on a screen has been detected, a character associated with the key in the detection area;
determining, when a modification of the character that was input at the inputting has been detected, whether the key of the pre-modification character is adjacent to a key of a post-modification character in the layout of the software keyboard; and
extending, when it is determined at the determining that the key of the pre-modification character is adjacent to the key of the post-modification character, the detection area of the key that is associated with the post-modification character in the arrangement direction of the key that is associated with the pre-modification character.
